(19) United States
(12) Patent Application Publication
(10) Pub. No.: US 2026/0140494 A1
(43) Pub. Date: May 21, 2026

(54) MOTOR CONTROL CENTER MANAGEMENT INTERFACE WITH UNIT PROFILE VIEW

(71) Applicant: Rockwell Automation Technologies, Inc., Mayfield Heights, OH (US)

(72) Inventors: Hayley L. Jamiola, New Berlin, WI (US); Suzanne M. Michelich, Brookfield, WI (US); Peter J. Flickinger, Oak Creek, WI (US); Brandon C. Uniewski, Greenfield, WI (US); Andrew G. Beugnet, Milwaukee, WI (US); Andrew T. Dudley, Whitewater, WI (US); Todd A. Vance, West Bend, WI (US)

(21) Appl. No.: 18/949,291

(22) Filed: Nov. 15, 2024

(51) Int. Cl. G05B 19/418; G06F 3/04842

(52) U.S. Cl. CPC G05B 19/418; G06F 3/04842

(57) ABSTRACT

A remote motor control center (MCC) interface with a unit profile view. Information about the MCC units is obtained from a data file containing project data for the MCC. Status data is collected for the units. An elevation view showing the units of the MCC is generated, which includes background and contextual information for each of the units and the motor control devices therein. The elevation view includes selectable elements for the MCC units. In response to receiving a selection of a selectable element, the unit devices for the corresponding unit are identified. A network path facilitating communication with the unit devices is identified and leveraged for attempts to instantiate monitoring for the unit devices. Based on the attempts to instantiate monitoring and any successful monitoring, a unit profile for the unit is generated. The unit profile includes at least type and status information for the unit devices.

### BACKGROUND

Industrial motor control centers (MCCs) are integral components in modern manufacturing, processing, and power distribution facilities. MCCs are designed to house various motor control devices which can be leveraged to govern the starting, stopping, speed, protection, and monitoring of motors that drive industrial equipment. By centralizing these controls within a unified system, MCCs provide operators with convenient and efficient means of managing multiple motors within a facility. This centralization improves operational efficiency, reduces energy consumption, and ensures that machinery operates within safe and controlled parameters. MCCs are organized into sections, where each section of the MCC contains units, and each unit of the MCC contains one or more of the motor control devices. The motor control devices of each unit, which may include any number of variable frequency drives, relays, starters, contactors, and the like, typically correspond to the management of the operation of a single industrial motor.

In recent years, advancements in industrial automation have introduced the possibility of remotely accessing and interfacing with MCCs. By integrating remote capabilities, operators and maintenance personnel can monitor and control motor performance by interacting with the motor control devices of each unit of the MCC via a graphical user interface (GUI). This shift has enabled organizations to respond faster to system changes, optimize motor function on-the-fly, and preemptively address faults that may lead to unplanned shutdowns.

A significant difficulty in managing motor control systems remotely, however, lies in the challenge of effectively aggregating the full scope of available information for each motor control device within an MCC unit. Effective remote management requires a comprehensive view of each motor control device's operational parameters, historical data, and performance analytics, as well as real-time metrics such as temperature, voltage, load, and vibration levels, for example.

Unfortunately, in many remote MCC services, this information is either dispersed across various systems or unavailable in a standardized format, making it difficult for remote operators to access and interpret a cohesive dataset. Without streamlined access to background, contextual, and real-time data, operators are left with an incomplete picture of the MCC device, which complicates diagnostics, slows response times, and increases the risk of misinformed adjustments that could lead to equipment stress or failure.

### SUMMARY

To streamline access to the full scope of information available for the units of a motor control center (MCC), methods and systems are disclosed for providing a remote MCC interface with a unit profile view of an MCC unit. A data file having project data relating to an MCC of an industrial environment is accessed. Status data is obtained corresponding to multiple units of the MCC. The units of the MCC each include some number of industrial devices. The one or more industrial devices corresponding to a given unit are referred to as the unit devices for that given unit. A graphical user interface (GUI) is then generated. The GUI includes an elevation view of the MCC, which includes a virtual representation of the motor control center and each of the units therein. In response to receiving a selection of a selectable element associated with a unit of the MCC via the GUI, the unit devices for that unit are identified. A network path facilitating communication with the unit devices is identified, and attempts are made to instantiate monitoring for each of the unit devices via the identified network path. Based on the attempts to instantiate monitoring and any successfully instantiated monitoring, a unit profile for the unit is generated via the GUI. The unit profile includes type information for each of the unit devices, and a status for each of the unit devices.

In some scenarios, obtaining the status data corresponding to the multiple units of the MCC includes periodically obtaining the status data corresponding to the multiple units of the MCC. In some scenarios, based on the periodic obtaining of status data corresponding to the multiple units of the MCC, a status change for one of the unit devices is identified. Based on the status change, a status alert is generated via the GUI. The status alert includes an indication referencing which of the unit devices is associated with the status change and an indication of what the current status of that device is.

In some scenarios, one of the unit devices is a primary industrial device. In other words, one device in the unit may be designated as the main device (i.e., primary device). In such scenarios, in response to receiving a selection of a selectable element associated with the primary industrial device, one or more of a device parameter of the primary industrial device, a device description of the primary industrial device, and an internet protocol address of the primary industrial device is modified.

In some scenarios, the unit profile includes one or more selectable elements. In such scenarios, each of the one or more selectable elements is associated with a device within the unit's list of devices. In response to receiving a selection of one of the one or more selectable elements, a view of additional information is generated. The additional information includes one or more of historical trends for the unit device in question and real-time data for the unit device in question.

In some scenarios, an input and output mapping is identified for one or more of the unit devices based on the project data. In some such scenarios, an output from the input and output mapping for one unit device can be leveraged as an input to the input and output mapping of another unit device. In some scenarios, the unit profile includes one or more links associated with the unit devices. In response to receiving a selection of one of the one or more links associated with one of the unit devices, a device profile is generated for the unit device corresponding to the link. The device profile includes information specific to the unit device corresponding to the link. The information specific to the unit device corresponding to the link includes documentation for the unit device. In some scenarios, one of the unit devices is a primary industrial device. In some such scenarios, the primary industrial device is a variable frequency drive.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in accordance with some embodiments of the present technology.

FIG. 2 illustrates a detailed view of elements of a system in accordance with some embodiments of the present technology.

FIG. 3 illustrates a method in accordance with some embodiments of the present technology.

FIG. 4 illustrates an operational sequence in accordance with some embodiments of the present technology.

FIG. 5 illustrates an elevation view in accordance with some embodiments of the present technology.

FIG. 6 illustrates a selectable element in accordance with some embodiments of the present technology.

FIG. 7 illustrates a unit profile in accordance with some embodiments of the present technology.

FIG. 8 illustrates a computing system used in accordance with some embodiments of the present technology.

### DETAILED DESCRIPTION

Disclosed herein are systems and methods for providing a unit profile for a unit of a motor control center (MCC) in industrial settings. Information regarding each of the units of the MCC is obtained through access to a data file containing project data for the MCC. Status data is then acquired for the multiple MCC units (also referred to simply as “units”). An elevation view of each of the units of the MCC is generated via a graphical user interface (GUI). The elevation view generally includes background and contextual information for each of the units of the MCC and the motor control devices therein. The elevation view includes selectable elements associated with the one or more units of the MCC. In response to receiving a selection of a selectable element associated with one of the one or more units, the unit devices for that corresponding unit are identified. A network path facilitating communication with the unit devices is identified and leveraged for attempts to instantiate monitoring for each of the unit devices. Based on the attempts to instantiate monitoring and any successfully instantiated monitoring, a unit profile for the unit is generated via the GUI. The unit profile includes description and property information for the unit as a whole as well as description and property information (e.g., type information, relationship information, documentation links, and the like) for each of the unit devices. The unit profile also includes a status for each of the unit devices.

In some embodiments, the status data for the unit devices making up each of the units of the MCC is not collected until a selection of a selectable element of the GUI is received. In some such embodiments, status data is collected only for the unit corresponding to the selection of the selectable element. In some other such embodiments, status data for each of the unit devices for each of the units of the MCC are collected in response to receiving a selection of a selectable element. In some embodiments, the status data for each of the unit devices of each of the units of the MCC are collected in the background and periodically updated. In such embodiments, status monitoring is initiated for each of the unit devices of each unit of the MCC. In some such embodiments, a unit profile may be generated for one of the units of the MCC, at which point the ongoing status monitoring and status information obtained from the status monitoring can be used to populate the unit profile with information corresponding to the unit devices associated with the unit profile.

Beneficially, the concepts disclosed herein allow for improved management of an MCC, its constituent motor control devices, and the ancillary industrial motors and other industrial devices the MCC directs the operation of. By aggregating valuable background, contextual, as well as real-time data for each unit device in a unit of an MCC, the information is available to an operator in a streamlined fashion. This streamlining functions to mitigate the potentially substantial volume of labor required to collect a similar scope of information for an MCC by searching for and processing disparate pieces of data and information. As a result, remote management of MCCs may be performed in a much more cost-effective manner.

Additionally, the resource cost of effectively monitoring unit devices to obtain real-time data (e.g., status data) is improved. Embodiments of the techniques described herein provide for monitoring of unit devices only as necessary in addition to the benefits mentioned above. By attempting to instantiate monitoring for the unit devices in response to receiving a selection of a selectable element associated with one unit, no unnecessary monitoring is performed outside of where desired. Eliminating unnecessary monitoring from remote MCC control procedures mitigates the resource cost of carrying out management, diagnostic, and remedial procedures for the MCC.

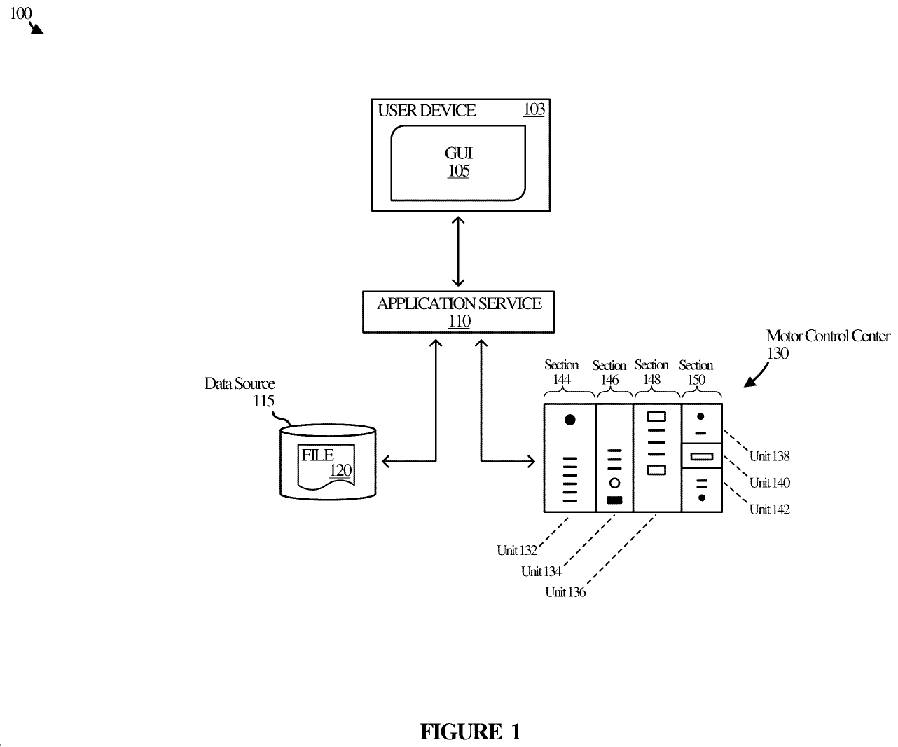

Now turning to the figures, FIG. 1 illustrates operational environment 100. Operational environment 100 is generally representative of an environment, or a combination of environments, in which remote management of a motor control center can be carried out. Operational environment 100 includes user device 103, application service 110, data source 115, and MCC 130. User device 103 further includes GUI 105. Data source 115 further includes file 120. MCC 130 further includes section 144, section 146, section 148, section 150, unit 132, unit 134, unit 136, unit 138, unit 140, and unit 142.

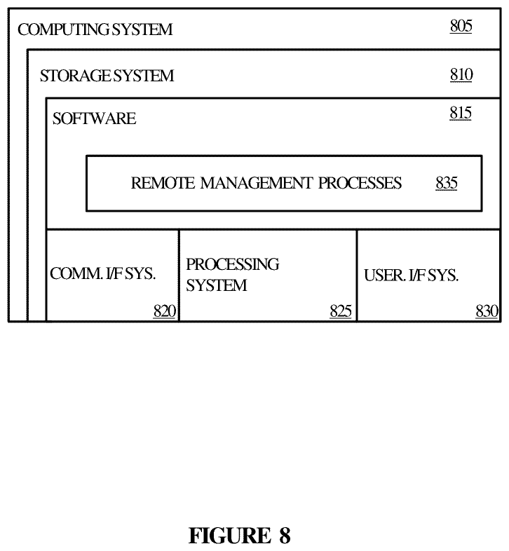

User device 103 is generally representative of a computing device capable of rendering GUI 105 and interfacing with application service 110 to facilitate remote management procedures of MCC 130. User device 103 may be a physical computing device and may also be a virtual computing device. An example of such a computing device is given by computing system 805 of FIG. 8 and is described in greater detail in the associated text. User device 103 may be located remotely to the other elements of operational environment 100 or may otherwise be located in a similar location to the elements of operational environment 100.

GUI 105 is generally representative of a graphical user interface that can be rendered to depict both an elevation view of unit 132, unit 134, unit 136, unit 138, unit 140, and unit 142 and a unit profile for each of unit 132, unit 134, unit 136, unit 138, unit 140, and unit 142, respectively. GUI 105 is further representative of a graphical user interface configured to receive inputs (i.e., selections of selectable elements). In response to the inputs, GUI 105 may modify a portion of the visible interface.

Application service 110 is generally representative of software, hardware, or firmware for remotely managing the operations of MCC 130 and its constituent elements. Application service 110 is configured to access file 120 of data source 115, to obtain status data and general unit properties for unit 132, unit 134, unit 136, unit 138, unit 140, and unit 142 and the industrial devices therein, respectively. Application service 110 may be hosted on a computing device (e.g., computing system 805 of FIG. 8) located in a variety of locations with respect to the other elements of operational environment 100 or may also be hosted in a cloud computing environment. An example of such software, hardware, or firmware is given generally by remote management processes 835 of FIG. 8, and in particular by the INTELLICENTER® extension to FACTORY TALK DESIGN STUDIO™ offered by ROCKWELL AUTOMATION®.

Data source 115 is generally representative of storage media sufficient to store file 120, and to provide application service 110 with access to file 120 as needed to carry out remote management processes for MCC 130. Data source 115 may be physical storage media, such as storage drives, flash media, and the like, or may also be virtual storage resources, such as cloud storage. Where data source 115 is implemented via physical storage media, data source 115 may be located proximate to any of other elements of operational environment 100, or remote to each of the elements of operational environment 100. File 120 is generally representative of a file containing project data that can be used to obtain information about MCC 130.

MCC 130 is generally representative of a motor control center having a number of sections and a number of units, each of which contain some number of industrial motor control devices. Each of section 144, section 146, section 148, section 150 are generally representative of sections of MCC 130 that may contain one or more units of MCC 130 (e.g., unit 132, unit 134, etc.) As illustrated in FIG. 1, section 144 includes unit 132, section 146 includes unit 134, section 148 includes unit 136, and section 150 includes unit 138, unit 140, and unit 142. In other scenarios, each of section 144, section 146, section 148, and section 150 may include any number of units of MCC 130.

The industrial motor control devices are used to govern the operation of various motors, and in some cases other industrial devices. Each unit of MCC 130 (e.g., unit 132, unit 134, unit 136, unit 138, unit 140, and unit 142) and its constituent elements are generally responsible for the operation and management of a single industrial motor or other industrial device. MCC 130 may include any number of sections, which may each contain any number of units, which may further include any number of industrial motor control devices. The one or more industrial motor control devices within each of unit 132, unit 134, unit 136, unit 138, unit 140, and unit 142 may include variable frequency drives, motor starter devices, electronic relays, sensing devices, and the like. MCC 130 is generally located in an industrial environment in which industrial motors are in use, such as a manufacturing facility or a processing plant. In such an environment, MCC 130 may be proximate to the one or more industrial motors or other industrial devices governed by unit 132, unit 134, unit 136, unit 138, unit 140, and unit 142 or may be located in other portions of the industrial environment. Examples of MCC 130 are given by the CENTERLINE 2100 LOW VOLTAGE MOTOR CONTROL CENTER and the FLEXLINE 3500 MOTOR CONTROL CENTER, both of which are provided by ALLEN-BRADLEY® BY ROCKWELL AUTOMATION®.

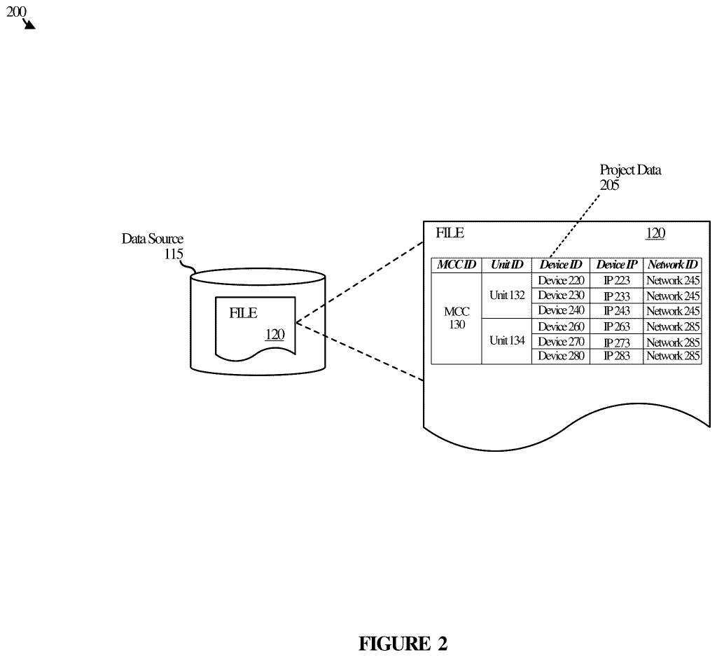

FIG. 2 illustrates detailed view 200 of elements of a system in accordance with some embodiments of the present technology. Detailed view 200 illustrates a more detailed representation of elements of operational environment 100. Detailed view 200 includes data source 115, which includes file 120, each of which are depicted in FIG. 1 and described in further detail in the corresponding text to FIG. 1. Detailed view 200 also illustrates an expanded view of file 120, similarly labeled as file 120. The expanded view of file 120 is shown to the right of the unexpanded view of file 120 and is connected to the unexpanded view of file 120 by a pair of dotted lines. The expanded view of file 120 is used to further illustrate elements within file 120, and in particular, to show project data 205.

Project data 205 is generally representative of data associated with one or more particular motor control centers, such as MCC 130 of FIG. 1. Project data 205 may contain information for any number of motor control centers and for each of the constituent elements of each motor control center. Project data 205 is typically structured data but may in some cases include unstructured data. Where project data 205 includes unstructured data, further processing of such data may be needed to leverage project data 205 in processes for remote motor control center management. Generally, project data 205 at least includes identifying information for one or more motor control centers, identifying information for each unit of each of the one or more motor control centers and the motor control center each unit corresponds to, identifying information for each of the devices in each units of each of the one or more motor control centers, internet protocol information for each of the devices in each units of each of the one or more motor control centers, and network information for each of the devices in each units of each of the one or more motor control centers. Project data 205 may also include section information that includes identifying information for one or more of section 144, section 146, section 148, and section 150, and identifying information for the motor control center corresponding to each of section 144, section 146, section 148, and section 150 (e.g., MCC 130). In certain scenarios, further information is included in project data 205. Such additional information may include a motor control center type for any motor control centers described therein, a device type for any devices described therein, relations and interdependencies between any devices described therein, the identity of any primary devices, and the like.

As shown in FIG. 2, data source 115 holds file 120 such that the information contained in file 120 can be retrieved as needed to facilitate remote management operations for motor control centers. Project data 205 is first accessed in order to acquire identifying information about one or more motor control centers and the elements and groupings therein. In some embodiments of the technology disclosed herein, the identifying information obtained from project data 205 is leveraged in order to acquire status information for each of the devices of each unit of each of the one or more motor control centers. In such embodiments, the internet protocol information corresponding to each device and the network information corresponding to each device is used to identify a communication path that can be used to establish communication to each of the devices. With the identified communication path, status information for each device of each unit can be obtained.

In an example operation of an embodiment, file 120 is accessed to facilitate obtaining status information for the elements of MCC 130. The motor control devices associated with each unit are identified and a network path allowing communication to the motor control devices is determined. As illustrated in FIG. 2, project data 205 shows information for two different units of MCC 130 labeled as unit 132 and unit 134. The motor control devices of MCC 130 are grouped into these units. Device 220, device 230, and device 240 are each associated with unit 132, while device 260, device 270, and device 280 are each associated with unit 134. Each of the devices associated with unit 132 have network identification information represented by network 245. Network 245 facilitates remote communication with each of device 220, device 230, and device 240, which can be individually queried based on the device internet protocol information for each device. In some scenarios, an intermediary communication element is leveraged to facilitate communication with, and information retrieval from, the unit devices of MCC 130 based on the device internet protocol information for each device. In such scenarios, an application service, such as application service 110 of FIG. 1, directs the communication intermediary to query a given unit device (e.g., device 220) of MCC 130. Device 220 corresponds to IP 223, device 230 corresponds to IP 233, and device 240 corresponds to IP 243. With the information from project data 205, status information for each of the devices of each of the units can be obtained. In some embodiments, obtaining the status information from each of device 220, device 230, and device 240, or from any other motor control device of MCC 130, is performed by attempting to instantiate monitoring on each of device 220, device 230, and device 240. The success, or failure, of attempts to instantiate monitoring procedures is one layer of data that can be used to contextualize the state of a given motor control device. Additionally, data retrieved through successfully instantiated monitoring can be used to inform analysis of the given motor control device.

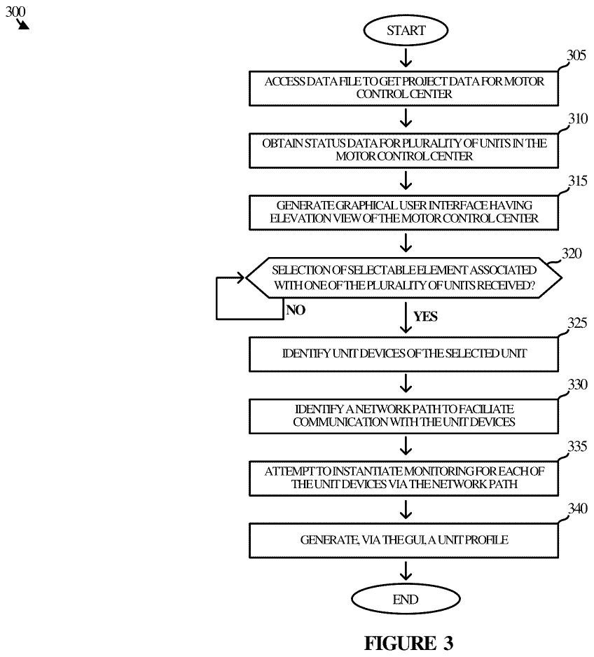

FIG. 3 illustrates method 300 in accordance with some embodiments of the present technology. The steps of method 300 are referenced parenthetically in the paragraphs that follow and may be carried out in the context of the systems and elements of operational environment 100 of FIG. 1 and project data 205 of FIG. 2, respectively. Method 300 is representative of method steps for providing a unit profile view in a remote MCC management interface.

To begin, a data file having project data relating to an MCC of an industrial environment is accessed (step 305). The data file (e.g., data file 120 of FIG. 1) is accessed from a data source (e.g., data source 115 of FIG. 1) in order to obtain the project data (e.g., project data 205). The project data may include a variety of information about the devices contained in the motor control center, such as device types, device interrelations, communication information, corresponding unit information, and the like. Based on the project data obtained from the data file, status data is obtained corresponding to multiple units of the MCC (step 310). An example of the process by which the project data can be used to obtain status data for the units of the MCC and the motor control devices therein is given in the text associated with FIG. 2. The units of the MCC each include some number of industrial devices. In some scenarios, a given unit of MCC 130 (e.g., unit 132) may include no unit devices that can be queried for a status, and thus no corresponding unit devices are shown for that given unit. The one or more industrial devices corresponding to a unit can be referred to as the unit devices for that unit.

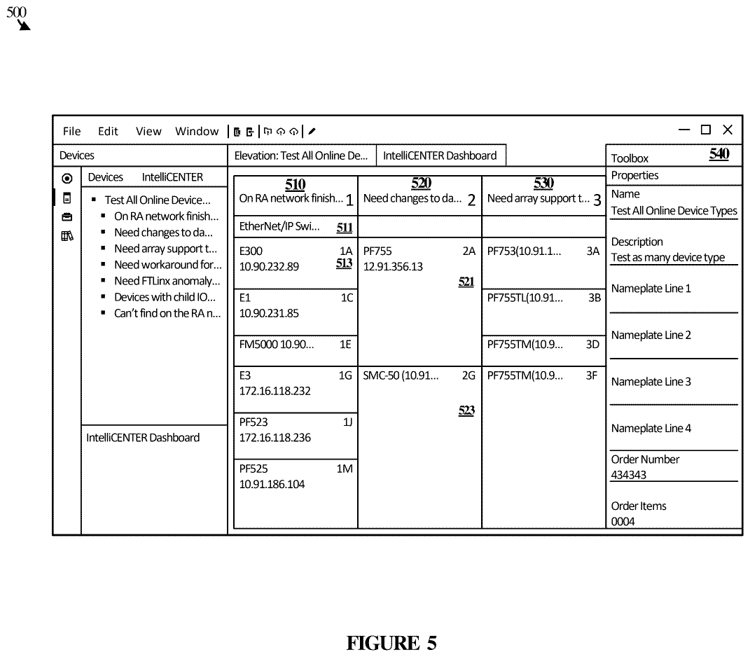

A graphical user interface (GUI) is then generated (step 315). The GUI includes an elevation view of the MCC, which includes a virtual representation of the motor control center, each of the sections of the motor control center, and each of the units therein. An example of such an elevation view is given by elevation view 500 of FIG. 5. In particular, the elevation view recreates one or more of the visual features of the physical motor control center such that a remote operator can leverage a similar degree of management and oversight when compared with an operator on the same premises as the motor control center and interacting with the motor control center in person. A selection of a selectable element associated with a unit (e.g., unit 134 of FIG. 2) of the MCC via the GUI (step 320). A selection of an interactable element may be a selection of a drop-down menu item, selection of a radial button or a similar element, a text entry, and the like. An operator may select an element of the elevation view in order to drill into the available information for a particular unit of the MCC.

Based on the selection of an element of the GUI associated with a unit of the MCC, the unit devices for that unit are identified (step 325). For example, the selection may correspond to unit 134 of FIG. 2, meaning the unit devices are device 260, device 270, and device 280. In another example, where the selection corresponds to unit 132, the unit devices are device 220, device 230, and device 240. Based on the selection and the identity of the unit devices, a network path facilitating communication with the unit devices is identified (step 330). Identifying the network path includes obtaining both network information for the unit devices and internet protocol address information for the unit devices, both of which are illustrated as included in project data 205 of FIG. 2. Leveraging the network path that facilitates communication to the unit devices, attempts are made to instantiate monitoring for each of the unit devices (step 335). Based on the attempts to instantiate monitoring and any successfully instantiated monitoring, a unit profile for the unit is generated via the GUI (step 340). The unit profile at least includes type information for each of the unit devices, and a status for each of the unit devices, but may further include any variety of contextual, real-time, or background information helpful to an operator executing remote MCC management processes.

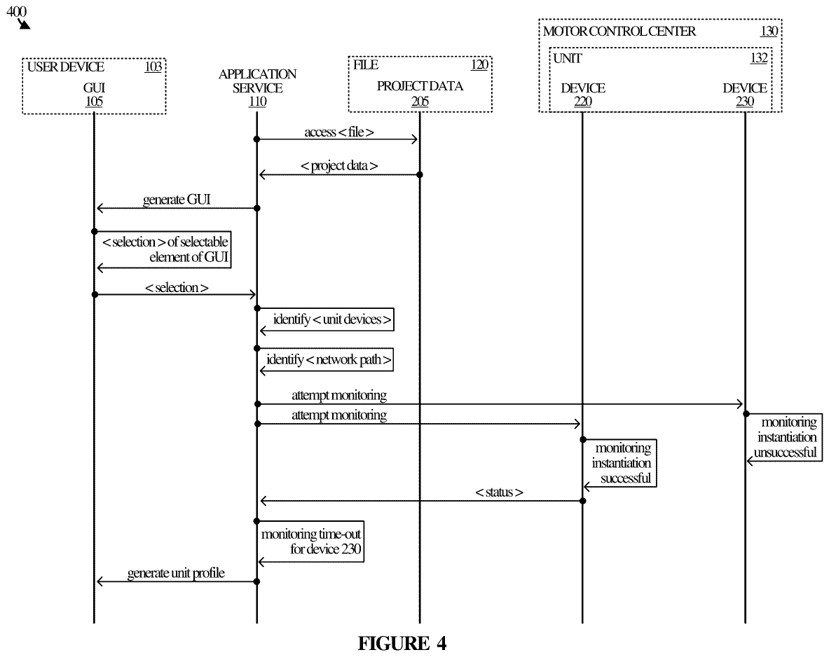

FIG. 4 illustrates operational sequence 400 in accordance with some embodiments of the present technology. Operational sequence 400 includes GUI 105 of user device 103, application service 110, MCC 130, and unit 132 of MCC 130, each of FIG. 1, respectively. Operational sequence 400 further includes project data 205 of file 120, device 220 of unit 132, and device 230 of unit 132, each of FIG. 2, respectively.

To begin, application service 110 queries file 120 in order to acquire certain information from project data 205. Application service 110 obtains the project data. In some cases, the project data is used to acquire real-time status data for the constituent elements of MCC 130. In some cases, the project data is used to contextualize the constituent elements of MCC 130 while real-time status data is acquired at a subsequent step. In either case, based on the project data, application service 110 generates a graphical user interface (GUI) to be displayed on user device 103. The GUI rendered on user device 103 is an elevation view of the units of MCC 130. The elevation view is a digital recreation of the view an operator interacting with MCC 130 in person may experience. A selection of an element of the GUI associated with a particular unit (i.e., unit 132 or unit 134) is received. Here, the selection corresponds to unit 132 of MCC 130. Based on the selection, a unit profile view of unit 132 and its constituent elements will be generated.

Application service 110 receives the selection and processes the selection to identify the unit devices corresponding to the selection. Device 220 and device 230 are identified as the unit devices of unit 132. Leveraging information available from project data 205, application service 110 identifies network paths that facilitate communication to the unit devices. Application service 110 attempts to instantiate monitoring for each of the unit devices. As illustrated here, the attempt to instantiate monitoring for device 220 was successful and resulted in a responsive communication including status information of device 220. The attempt to instantiate monitoring for device 230, however, fails and no response is received at application service 110. Having not received a response for some predetermined length of time, application service 100 times out the attempt to instantiate monitoring for device 230. Based on the successful instantiation of monitoring for device 220 and the unsuccessful instantiation of monitoring for device 230, the unit profile for unit 132 is generated on GUI 105.

FIG. 5 illustrates elevation view 500 in accordance with some embodiments of the present technology. Elevation view 500 includes section 510, section 520, section 520, and toolbox 540. Section 510 further includes motor control wireway 511 and unit 513. Section 520 includes unit 521 and unit 523.

Elevation view 500 is representative of a high-level view of a motor control center, such as MCC 130. Elevation view 500 provides background and contextual information for the elements of the motor control center, allowing remote management of the motor control center to be carried out on an informed basis.

Each of section 510, section 520, and section 530 are representative of portions of the elevation view that each respectively correspond to a unique unit of the motor control center (e.g., unit 132 or unit 134 of FIG. 1). The data in each of section 510, section 520, and section 530 provides a remote operator with a high-level view of the motor control devices in each unit of the MCC, as well as other kinds of information. As illustrated in FIG. 5, section 510 includes a motor control wireway 511 and unit 513. Motor control wireway 511, which corresponds to the device or devices found in the physical MCC wireway in section 510. Unit 513 of section 510 is labeled with the text E300, which denotes the device type of an industrial motor control device corresponding to unit 513. Here E300 corresponds to an E300 ELECTRONIC OVERLOAD RELAY, an ALLEN-BRADLEY® BY ROCKWELL AUTOMATION® product designed for overload protection in electronic circuits.

Section 520 contains a different set of units and thus a different set of motor control devices than section 510, which can be distinguished by their various identifying information. Unit 521 is labeled with the text PF755, which corresponds to a POWERFLEX 755 AC DRIVE, an ALLEN-BRADLEY® BY ROCKWELL AUTOMATION® product designed to produce input signals to drive devices such as industrial motors. Unit 523, also included in section 520, is labeled with the text SCM-50. SMC-50 corresponds to an SMC-50 SOFT STARTER, an ALLEN-BRADLEY® BY ROCKWELL AUTOMATION® product designed to reduce mechanical stress and spikes in current (i.e., inrush current) in the startup procedures for certain industrial motors by gradually increasing the voltage of the input.

Toolbox 540 is representative of a portion of the elevation view configured to provide various functionality to an operator carrying out remote motor control center management. In some examples, interacting with certain elements of elevation view 500 result in the reconfiguration of the features and information shown in toolbox 540. Notably, toolbox 540 and the features therein generally lack the ability to interact with motor control devices on an individual level and instead provide generalized features that can uniformly be applied to the motor control devices of a motor control center.

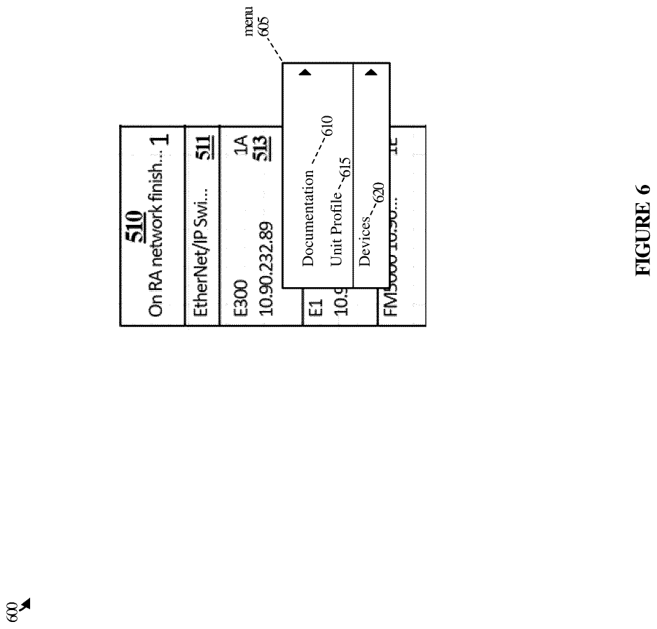

FIG. 6 illustrates selectable elements 600 in accordance with some embodiments of the present technology. Selectable elements 600 is representative of one or more selectable elements of an elevation view (e.g., elevation view 500 of FIG. 5) that, when selected, allow a remote operator of a motor control center to dig into background, contextual, and real-time information available for a motor control device or unit. As illustrated in FIG. 6, a portion of section 510 of FIG. 5 is shown. Section 510 similarly includes motor control wireway 511 and unit 513, which are described in additional detail in the associated text to FIG. 5. Selectable elements 600 further includes menu 605, documentation 610, unit profile 615, and devices 620. Selectable elements 600 may further include additional elements that have not been illustrated here for simplicity.

Menu 605 is representative of a drop-down menu that when interacted with, provides additional selectable elements or information. In an example, an operator reveals menu 605 by right clicking on a unit corresponding to section 510. As shown here, menu 605 originates from unit 513 of section 510. As a result, certain features of menu 605 may be specific to unit 513.

Documentation 610 is representative of a selectable element that, when selected, returns any document references available with regard to the unit in question, here being unit 513. In other examples, selection of documentation 610 may return documentation for each of the motor control devices of the unit. For example, as illustrated here, a selection of documentation 610 of menu 605 may return documentation specific to unit 513. As determined in the text associated with FIG. 5, unit 513 corresponds to an E300 ELECTRONIC OVERLOAD RELAY. Selection of documentation 610 with respect to unit 513 will return documentation for an E300 ELECTRONIC OVERLOAD RELAY.

Unit profile 615 is representative of a selectable element, that when selected, results in the generation of a unit profile. Here, menu 605 is shown with regard to unit 513. As such, a selection of unit profile 615 will result in the generation of a unit profile for the unit of the motor control center corresponding to unit 513. The unit profile includes real-time data for each of the motor control devices of the unit in addition to the background and contextual information available from project data. In some scenarios, the unit profile further information for the unit or the motor control devices therein, such as historical operation data and additional real-time metrics, such as input and output characteristics.

In some scenarios, an input and output mapping is identified for the motor control devices of a given unit. In some such scenarios, the output from the mapping for one unit device can be leveraged as an input to the mapping for another unit device. In such scenarios, additional information can be inferred about the operation and state of the motor control devices within each unit based on the operation and state of corollary devices.

In some cases, the unit profile includes one or more links associated with the unit devices. In response to receiving a selection of one of the one or more links associated with one of the unit devices, a device profile is generated for the unit device corresponding to the link. The device profile includes information specific to the unit device corresponding to the link. The information specific to the unit device corresponding to the link includes documentation for the unit device.

In some embodiments of the technology, a primary device is denoted for the unit devices. The primary device (also referred to as the main device) can be prioritized such that information is most prominently illustrated for the primary device. Additionally, the unit profile allows for remote interaction with the primary device on an individual level, allowing for finer resolution control of the motor control devices and therefore finer control of the industrial motor device that the motor control devices govern.

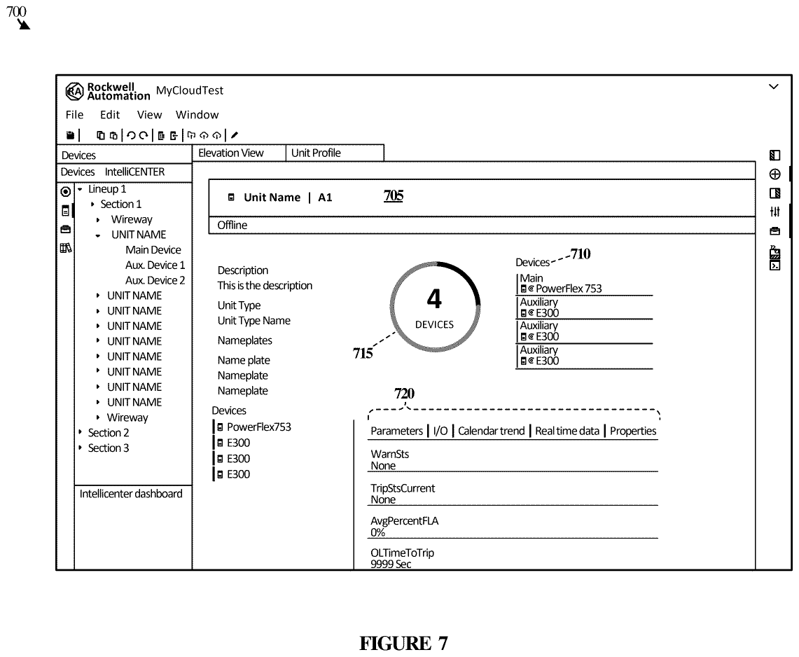

FIG. 7 illustrates unit profile 700 in accordance with some embodiments of the present technology. Unit profile 700 is generally representative of a view of a unit of a motor control center, such as MCC 130, that provides background, contextual, real-time, and other forms of information about the motor control devices within the unit in question.

Unit profile 700 contains identifying information 705 for the unit, device index 710 of the motor control device (i.e., unit devices) within the unit, unit device statuses 715, and additional information 720. Based on which unit of a motor control center that unit profile 700 is generated for, each of identifying information 705, device index 710, and unit device statuses 715, and additional information 720 may be different when compared to a unit profile generated for another unit.

Identifying information 705 includes a name of the unit for which the unit profile is generated. In some examples, unit profile 700 further includes certain high-level information about the unit at large, such as a description of the unit, a unit type of the unit, and the like. An operator carrying out remote management of a motor control center may be able to more efficiently sort through the units of the motor control center by referencing identifying information 705.

As discussed in the text to previous figures, the generation of a unit profile occurs in response to the selection of a selectable element associated with a particular unit. In response to receiving the selection, a unit profile is generated for the unit corresponding to the selection. Here, the unit profile is generated for a unit of a motor control center having a unit location A1. Unit at location A1 includes four different motor control devices, each of which are listed in device index 710. Device index 710 lists, as the unit devices for unit located at A1, a POWERFLEX 753 device and three separate E300 ELECTRONIC OVERLOAD RELAY devices. Status information for each of the unit devices is shown by unit device statuses 715.

Unit device statuses 715 show the total number of unit devices inside a circular chart indicating a proportion of the unit devices having a particular status. Typically, unit device statuses may show a status corresponding to successful attempts to instantiate monitoring, or otherwise status corresponding to devices that are enabled and ready for operation, though unit devices statuses 715 may be configured to illustrate a variety of status metrics for the unit devices. As shown here, unit device statuses 715 show that of the four unit devices in unit located at A1, three have a particular status while one has a different status. This is illustrated by the fraction of the ring element in unit device statuses 715 shaded in one color versus another but may be illustrated by a variety of visual means. In this scenario, three of the four devices are in an operational state, while one of the unit devices is not.

Unit profile 700 beneficially allows a remote operator of a motor control center to further investigate the states of the unit devices of unit located at A1 by leveraging efficiently aggregated background, contextual, and real-time data for each of the unit devices in a simple and direct interface. Where the operator desires further information to inform such investigations, one or more selectable tabs of additional information 720 may be used.

Additional information 720 is a configurable portion of unit profile 700 in which many different kinds of information for motor control devices can be evaluated, such as device parameters of motor control devices, input and output correlations of motor control devices, historical operation trends of motor control devices, real-time data for motor control devices, and properties of motor control devices. In some examples, device documentation for the unit devices may be located in additional information 720.

In an example operation, a remote operator of a motor control center may wish to further investigate the single unit device having a different status from the other three unit devices of unit located at A1. Using unit profile 700, the operator can identify the unit device having the irregular status and review a wide variety of background, contextual, and real-time data in order to come to a complete understanding of the issue that unit device is experiencing. Based on the full scope of available information for that unit device, the remote operator is positioned to make an informed decision regarding how the issue can or should be responded to.

FIG. 8 illustrates computing system 805 used in accordance with some embodiments of the present technology. Computing system 805 is generally representative of a computing device sufficient to execute remote management processes 835. In some embodiments, computing system 805 is representative of a user device, such as user device 103 of FIG. 1.

Computing system 805 is representative of a computing device sufficient to execute software and communicate with peripherals. Computing system 805 is representative of any system or collection of systems with which the various operational architectures, processes, scenarios, and sequences disclosed herein. Computing system 805 may be implemented as a single apparatus, system, or device or may be implemented in a distributed manner as multiple apparatuses, systems, or devices. Computing system 805 includes, but is not limited to, processing system 825, storage system 810, software 815, communication interface system 820, and user interface system 830. Processing system 825 is operatively coupled with storage system 810, communication interface system 820, and user interface system 830. Computing system 805 may be representative of a cloud computing device, distributed computing device, or the like.

Processing system 825 loads and executes software 815 from storage system 810. Software 815 includes and implements remote management processes 835. When executed by processing system 825 to provide remote management processes 835, software 815 directs processing system 825 to operate as described herein for at least the various processes, operational scenarios, and sequences discussed in the foregoing implementations. Computing system 805 may optionally include additional devices, features, or functionality not discussed for purposes of brevity.

Processing system 825 may include a microprocessor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, graphical processing units, application specific processors, and logic devices, as well as any other type of processing device, combinations, or variations thereof.

Storage system 810 may include any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 810 may also include computer readable communication media over which at least some of software 815 may be communicated internally or externally. Storage system 810 may be implemented as a single storage device but may also be implemented across multiple storage devices or sub-systems co-located or distributed relative to each other. Storage system 810 may include additional elements, such as a controller capable of communicating with processing system 825 or other systems.

Software 815 (including remote management processes 835) may be implemented in program instructions and, when executed by processing system 825, can direct processing system 825 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 815 may include additional processes, programs, or components, such as operating system software, virtualization software, or other application software. Software 815 may also include firmware or some other form of machine-readable processing instructions executable by processing system 825.

In general, software 815 may, when loaded into processing system 825 and executed, transform a suitable apparatus, system, or device (of which computing system 805 is representative) overall from a general-purpose computing system into a special-purpose computing system customized to provide remote management processes 835 as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The media, connections, and devices are well known and need not be discussed at length here.

Communication between computing system 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The communication networks and protocols are well known and need not be discussed at length here.

While some examples provided herein are described in the context of an industrial environment, it should be understood that the systems and methods described herein are not limited to such embodiments and may apply to a variety of other industrial environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method, comprising:
accessing a data file comprising project data for a motor control center of an industrial automation environment;
obtaining status data corresponding to a plurality of units in the motor control center, wherein each unit of the plurality of units comprises unit devices consisting of one or more industrial devices;
generating a graphical user interface comprising an elevation view of the motor control center, wherein the elevation view comprises a virtual representation of the motor control center including each of the plurality of units; and
in response to receiving a selection of a selectable element associated with a unit of the plurality of units:
identifying the unit devices of the unit based at least in part on the project data,
identifying a network path to facilitate communication with the unit devices,
attempting to instantiate monitoring of each of the unit devices using the network path and an associated address from the project data, and
generating, via the graphical user interface, a unit profile based, at least in part, on the attempt to instantiate the monitoring and any successfully instantiated monitoring, wherein the unit profile comprises a device type of each of the unit devices and a status of each of the unit devices.

2. The method of claim 1, wherein obtaining the status data corresponding to the plurality of units in the motor control center comprises:
periodically obtaining the status data corresponding to the plurality of units in the motor control center.

3. The method of claim 2, the method further comprising:
identifying, based on the periodically obtaining the status data, a status change for one of the unit devices; and
generating, based on the status change, a status alert via the graphical user interface, wherein the status alert comprises an indication of the one of the unit devices associated with the status change and a current status of the one of the unit devices associated with the status change.

4. The method of claim 1, wherein:
one of the unit devices is a primary industrial device; and
the method further comprises, in response to receiving a selection of a selectable element associated with the primary industrial device, modifying, for the primary industrial device, one or more of a device parameter, a device description, and an internet protocol address.

5. The method of claim 1, wherein:
the unit profile further comprises one or more selectable elements;
each of the one or more selectable elements is associated with a unit device of the unit devices; and
the method further comprises generating, in response to receiving a selection of one of the one or more selectable elements associated with one of the unit devices, a view of additional information for the one of the unit devices, the additional information comprising one or more of historical trends for the one of the unit devices and real-time data for the one of the unit devices.

6. The method of claim 1, the method further comprising:
identifying, based on the project data, an input and output mapping for one or more of the unit devices.

7. The method of claim 1, wherein:
the unit profile further comprises one or more links associated with the unit devices; and
the method further comprises generating, in response to receiving a selection of one of the one or more links associated with one of the unit devices, a device profile comprising information specific to the one of the unit devices, wherein the information comprises access to documentation corresponding to the one of the unit devices.

8. The method of claim 1, wherein:
one of the unit devices is a primary industrial device; and
the primary industrial device is a variable frequency drive.

9. A computing device, comprising:
one or more computer readable storage media;
one or more processors operatively coupled with the one or more computer readable storage media; and
a data storage system comprising program instructions stored on the one or more computer readable storage media, wherein the program instructions, when executed by the one or more processors, direct the computing device to at least:
access a data file comprising project data for a motor control center of an industrial automation environment;
obtain status data corresponding to a plurality of units in the motor control center, wherein each unit of the plurality of units comprises unit devices consisting of one or more industrial devices;
generate a graphical user interface comprising an elevation view of the motor control center, wherein the elevation view comprises a virtual representation of the motor control center including each of the plurality of units; and
in response to receiving a selection of a selectable element associated with a unit of the plurality of units:
identify the unit devices of the unit based at least in part on the project data,
identify a network path to facilitate communication with the unit devices,
attempt to instantiate monitoring of each of the unit devices using the network path and an associated address from the project data, and
generate, via the graphical user interface, a unit profile based, at least in part, on the attempt to instantiate the monitoring and any successfully instantiated monitoring, wherein the unit profile comprises a device type of each of the unit devices and a status of each of the unit devices.

10. The computing device of claim 9, wherein the program instructions directing the computing device to obtain the status data corresponding to the plurality of units in the motor control center further comprise instructions that, when executed, direct the computing device to:
periodically obtain the status data corresponding to the plurality of units in the motor control center.

11. The computing device of claim 10, wherein the program instructions further comprise instructions that, when executed, direct the computing device to:
identify, based on periodic the status data, a status change for one of the unit devices; and
generate, based on the status change, a status alert via the graphical user interface, wherein the status alert comprises an indication of the one of the unit devices associated with the status change and a current status of the one of the unit devices associated with the status change.

12. The computing device of claim 9, wherein:
one of the unit devices is a primary industrial device; and
the program instructions further comprise instructions that, when executed, direct the computing device to:
in response to receiving a selection of a selectable element associated with the primary industrial device, modify, for the primary industrial device, one or more of a device parameter, a device description, and an internet protocol address.

13. The computing device of claim 9, wherein:
the unit profile further comprises one or more selectable elements;
each of the one or more selectable elements is associated with a unit device of the unit devices; and
the program instructions further comprise instructions that, when executed, direct the computing device to:
generate, in response to receiving a selection of one of the one or more selectable elements associated with one of the unit devices, a view of additional information for the one of the unit devices, the additional information comprising one or more of historical trends for the one of the unit devices and real-time data for the one of the unit devices.

14. The computing device of claim 9, wherein the program instructions further comprise instructions that, when executed, direct the computing device to:
identify, based on the project data, an input and output mapping for one or more of the unit devices.

15. The computing device of claim 9, wherein:
the unit profile further comprises one or more links associated with the unit devices; and
the program instructions further comprise instructions that, when executed, direct the computing device to:
generate, in response to receiving a selection of one of the one or more links associated with one of the unit devices, a device profile comprising information specific to the one of the unit devices, wherein the information comprises access to documentation corresponding to the one of the unit devices.

16. The computing device of claim 9, wherein:
one of the unit devices is a primary industrial device; and
the primary industrial device is a variable frequency drive.

17. One or more computer readable storage media having program instructions stored thereon that, when executed by one or more processors in a computing device, direct the computing device to at least:
access a data file comprising project data for a motor control center of an industrial automation environment;
obtain status data corresponding to a plurality of units in the motor control center, wherein each unit of the plurality of units comprises unit devices consisting of one or more industrial devices;
generate a graphical user interface comprising an elevation view of the motor control center, wherein the elevation view comprises a virtual representation of the motor control center including each of the plurality of units; and
in response to receiving a selection of a selectable element associated with a unit of the plurality of units:
identify the unit devices of the unit based at least in part on the project data,
identify a network path to facilitate communication with the unit devices,
attempt to instantiate monitoring of each of the unit devices using the network path and an associated address from the project data, and
generate, via the graphical user interface, a unit profile based, at least in part, on the attempt to instantiate the monitoring and any successfully instantiated monitoring, wherein the unit profile comprises a device type of each of the unit devices and a status of each of the unit devices.

18. The one or more computer readable storage media of claim 17, wherein the program instructions further direct the computing device to:
periodically obtain the status data corresponding to the plurality of units in the motor control center.

19. The one or more computer readable storage media of claim 18, wherein the program instructions further direct the computing device to:
identify, based on periodic the status data, a status change for one of the unit devices; and
generate, based on the status change, a status alert via the graphical user interface, wherein the status alert comprises an indication of the one of the unit devices associated with the status change and a current status of the one of the unit devices associated with the status change.

20. The one or more computer readable storage media of claim 17, wherein:
one of the unit devices is a primary industrial device; and
the program instructions further comprise instructions that, when executed, direct the computing device to:
in response to receiving a selection of a selectable element associated with the primary industrial device, modify, for the primary industrial device, one or more of a device parameter, a device description, and an internet protocol address.
